(19) United States
(12) Patent Application Publication
(10) Pub. No.: US 2007/0171933 A1
(43) Pub. Date: Jul. 26, 2007

(54) MEDIUM ACCESS CONTROL AND PHYSICAL LAYER HEADERS FOR HIGH THROUGHPUT DATA IN WLAN SYSTEMS

(75) Inventors: Mohammed Sammour, Montreal (CA); Sudheer A. Grandhi, Mamaroneck, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/612,224

(22) Filed: Dec. 18, 2006

Related U.S. Application Data
(60) Provisional application No. 60/761,257, filed on Jan. 23, 2006.

(51) Int. Cl. H04L 12/413

(52) U.S. Cl. 370/447

(57) ABSTRACT

A method and apparatus are provided for signaling collision avoidance behavior, and in particular deferral and/or backoff behavior, within a communication frame. Preferably, collision avoidance data is explicitly communicated and wireless transmit/receive units (WTRUs) are configured to use such data to generate instructions to control the WTRUs' deferral, backoff and/or other collision avoidance behavior. Instructions generated by the WTRU in this regard may take the form of simply adjusting one or more timing control values used to dictate deferral, backoff and/or other collision avoidance behavior.

### CROSS REFERENCE TO RELATED APPLICATIONS

This application claims the benefit of U.S. Provisional Patent Application No. 60/761,257 filed on Jan. 23, 2006 which is incorporated by reference as if fully set forth.

### FIELD OF INVENTION

The present invention generally relates to wireless local area networks (WLANs), and more particularly, to a method, system and components for enhancing the performance of a WLAN communications.

### BACKGROUND

Wireless communication systems are well known in the art. Generally, such systems comprise communication stations (STAs), which transmit and receive wireless communication signals between each other. Depending upon the type of system, communication stations typically are one of two types: base stations or wireless transmit/receive units (WTRUs), which include mobile units.

The term base station as used herein includes, but is not limited to, a base station, Node B, site controller, access point or other interfacing device in a wireless environment that provides WTRUs with wireless access to a network with which the base station is associated.

The term WTRU as used herein includes, but is not limited to, a user equipment, mobile station, fixed or mobile subscriber unit, pager, or any other type of device capable of operating in a wireless environment. WTRUs include personal communication devices, such as phones, video phones, and Internet ready phones that have network connections. In addition, WTRUs include portable personal computing devices, such as PDAs and notebook computers with wireless modems that have similar network capabilities. WTRUs that are portable or can otherwise change location are referred to as mobile units. A base station is a type of WTRU.

One type of wireless system, called a wireless local area network (WLAN), typically has one or more access points (APs) and can be configured to conduct wireless communications with WTRUs equipped with WLAN modems. FIG. 1 illustrates an example of a WLAN made up of WTRUs including STAs 100, 102, 103, 104 and AP 106 with the AP's coverage area 110 being illustrated. WTRUs generally include various components such as a transmitter component 100_{T}, a receiver component 100_{R}, a processor component 100_{P} and a memory component 100_{M} which are illustrated with respect to STA 100. WLANs can operate in infrastructure mode, where the WTRUs communicate with one or more access points, or in ad hoc mode, where non-base station WTRUs can communicate directly with each other in addition to communicating with the APs.

There are various well-known WLAN communication standards which include, but are not limited to, Bluetooth and the IEEE 802.11 family of standards. With respect to accessing the shared wireless medium according to the 802.11 standards, STAs may use carrier sensing to determine if the medium is idle, and then defer transmitting a frame over the channel for a deferral period. Interframe spacing (IFS), as defined by the IEEE 802.11 (1999) standard, refers to a deferral period between frames, and the network allocation vector (NAV) provides a time period during which a STA is not permitted to transmit its frame.

Various different types of IFSs are illustrated in FIG. 2, which are used to provide different priorities. These include distributed coordination function (DCF) interframe space (DIFS) (which has evolved into arbitration interframe space (AIFS) in the 802.11e amendment), Point Coordination IFS (PIFS), Recovery InterFrame Space (RIFS) (not shown), Short Inter Frame Space (SIFS) and extended interframe space (EIFS) (not shown).

Generally, a STA may transmit a frame after DIFS following the reception of an error-free frame, and a STA may transmit a frame after EIFS following the reception of an erroneous frame, provided it is not before the NAV value. EIFS is longer than DIFS (or AIFS) to allow time for the transmission of an Acknowledgement (ACK) control frame. This is necessary to avoid collisions as a result of the hidden node or hidden station problem, which is well known in the art.

The following example describes a possible hidden station scenario in FIG. 1. Assume STA 104 is a hidden station with respect to STA 102 implying that STA 102 is not within range to receive frames transmitted by STA 104. STA 103 transmits a frame to STA 104, such that STA 102 receives the frame erroneously. If STA 102 attempts to transmit too soon following the erroneous reception, for example to AP 106, its frame will collide at receiving STA 103 with the ACK or response frame that will be sent by STA 104. Therefore, STA 102 defers for EIFS to allow time for STA 104 to send an ACK frame to STA 103.

The IEEE 802.11 standard is constantly evolving and has gone through many revisions, including, but not limited to, 802.11a, 802.11b, 802.11e, 802.11g, and 802.11n. The proposed 802.11n standard promises higher data throughputs than its predecessors by supporting new physical layer (PHY) and medium access layer (MAC) features. Such features include sending bursts of packets, and sending block ACKs (i.e. an aggregation of a plurality of acknowledgements into one frame). Such features imply that not every frame transmitted may be followed by an ACK frame or a response frame. In such cases, STAs deferring for EIFS may cause the channel to be idle for the duration of an ACK transmission. Idling of the channel contributes to a decrease in data throughput and overall performance degradation. Additionally, the duration of response frames may vary, since multiple types of responses are possible including, but not limited to, ACK frames, block ACK (BA) frames, reverse Direction (RD) traffic, and poll response frames.

In the prior art standards and proposed standards, STAs set or update their NAV value only when the received frame's NAV value, as indicated by the duration and ID, is higher than their local NAV value. The prior art does not permit a STA to decrease its local NAV to match the value in the received frame, and a local NAV value may be reset only upon receiving a CF-END frame.

Applicants have recognized a need for MAC support in WLANs to facilitate the setting of deferral behavior and updating of local NAV and longNAV values, to further exploit the benefits of high throughput communication standards where frame transmissions and corresponding acknowledgement and response frames vary in nature and duration.

### SUMMARY

A method and apparatus are provided for signaling collision avoidance behavior, and in particular deferral and/or backoff behavior, within a communication frame. Preferably, collision avoidance data is explicitly communicated and wireless transmit/receive units (WTRUs) are configured to use such data to generate instructions to control the WTRUs' deferral, backoff and/or other collision avoidance behavior. Instructions generated by the WTRU in this regard may take the form of simply adjusting one or more timing control values used to dictate deferral, backoff and/or other collision avoidance behavior.

Preferably, new fields for such explicit collision avoidance data are provided in conventional frame formats. One or more new fields within physical layer (PHY) headers, medium access layer (MAC) headers or any other part of communicated frames can be used to provide explicit collision avoidance data to WTRUs. Such data can then be received, decoded and used, for example, to control if and for how long the WTRU is to perform deferral before accessing the WLAN medium.

Preferably, collision avoidance data is included in fields, such as PHY header fields, which are decoded by a PHY layer of the WTRUs upon reception of the communication signals before processing by higher layers. This enables the collision avoidance behavior instructions to be generated without delay.

Optionally, explicit collision avoidance data can be provided in existing types of frame fields or included in a combination of new fields and conventional fields of WLAN communication frames. The WTRUs can be configured to use conventionally signaled data as collision avoidance data (herein referred to as “implicit” collision avoidance data) from which to generate instructions to control the WTRUs' deferral, backoff and/or other collision avoidance behavior. However, greater control and higher efficiency can generally be achieved where the WTRU is configured to use explicit collision avoidance data alone or in combination with implicit collision avoidance data to generate collision avoidance behavior instructions.

The signaling collision avoidance data can also be used to enable the WTRU to provide NAV or longNAV protection. For example, one or more fields within a received frame may serve to provide data to indicate if and how the receiving WTRU should set or reset its NAV or longNAV value.

Additionally, fields that typically appear in the MAC header that may also provide signaling information directed toward physical layer behavior, such as fields providing aggregation, channel sounding, or link adaptation signaling information, are preferably provided in the PHY layer header, instead of or in addition to being provided in the MAC header. This enables the signaling information to be provided to a receiving WTRU for PHY layer processing sooner and more reliably.

Other objects and advantages will be apparent to those of ordinary skill in the art based upon the following description of presently preferred embodiments of the invention.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is an illustration of a WLAN;

FIG. 2 shows examples of quantities used for interframe spacing;

FIG. 3A shows an example of a Physical Layer Convergence Procedure (PLCP) frame;

FIG. 3B shows an example of the HT-SIG header field of the frame illustrated in FIG. 3A;

FIG. 4 shows an example of fields containing deferral signals added to an HT-SIG field in accordance with an embodiment of the present invention; and

FIG. 5 is a flow diagram for signaling collision avoidance behavior within a frame in accordance with an embodiment of the present invention.

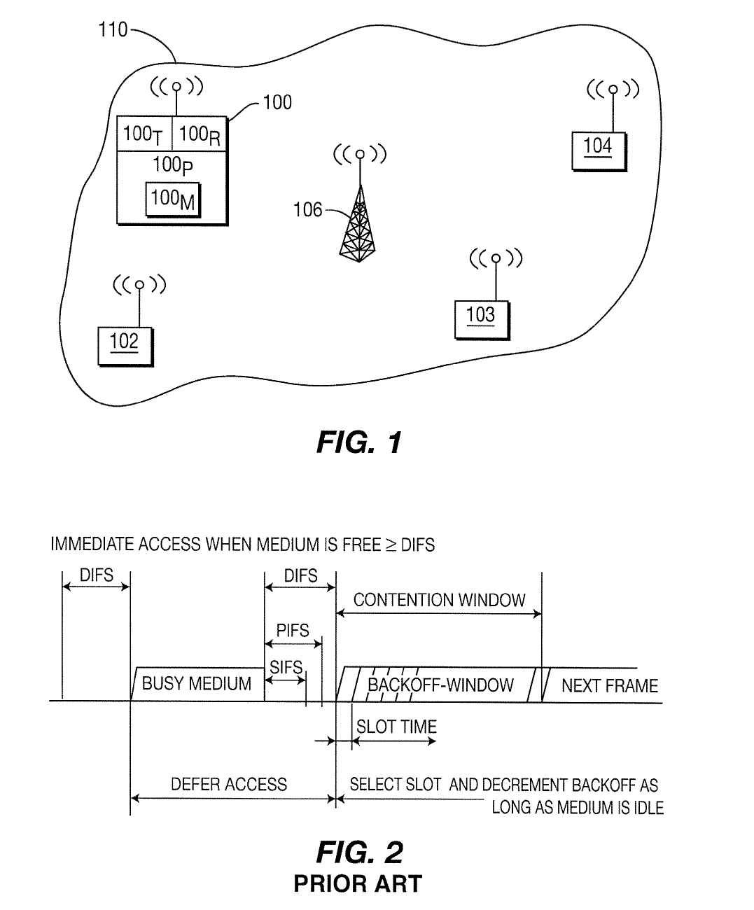

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

The present invention is described with reference to the figures wherein like numerals represent like elements throughout. In the following description, a field or an indicator (field) refer to a collection of one or more bits within a frame. Furthermore, a field may comprise one or more fields, as in the case of, for example, a high throughput signal (HT-SIG) field in a PLCP (i.e. physical layer) frame.

The present invention provides a method and apparatus in a wireless communication system, such as a wireless local area network (WLAN), for wireless transmit/receive units (WTRUs). WTRUs that receive and decode a communication frame, either fully or partially, are enabled to set deferral behavior and/or other behavior related to collision avoidance. The WTRUs can, accordingly, control their access to the wireless medium in response to signaling information/data contained within received frames. The present invention facilitates update of collision avoidance settings of WTRUs to enable recovery of the wireless medium more rapidly and to reduce the amount of time that a communication channel is idle. Settings and behavior for the purpose of collision avoidance include, but are not limited to, deferral periods including interframe spacing (IFS) deferrals such as, for example, extended IFS (EIFS), backoff periods, spoofed durations, network allocation vectors (NAVs) and longNAVs.

Preferably, collision avoidance data is explicitly communicated and wireless transmit/receive units (WTRUs) are configured to use such data to generate instructions to control the WTRUs' deferral, backoff and/or other collision avoidance behavior. Instructions generated by the WTRU in this regard may take the form of simply adjusting one or more timing control values used to dictate deferral, backoff and/or other collision avoidance behavior.

Preferably, new fields for such explicit collision avoidance data are provided in conventional frame formats. One or more new fields within physical layer (PHY) headers, medium access layer (MAC) headers or any other part of communicated frames can be used to provide explicit collision avoidance data to WTRUs. Such data can then be received, decoded and used, for example, to control if and for how long the WTRU is to perform deferral before accessing the WLAN medium.

Preferably, collision avoidance data is included in fields, such as PHY header fields, which are decoded by a PHY layer of the WTRUs upon reception of the communication signals before processing by higher layers. This enables the collision avoidance behavior instructions to be generated without delay.

Optionally, explicit collision avoidance data can be provided in existing types of frame fields or included in a combination of new fields and conventional fields of WLAN communication frames. The WTRUs can be configured to use conventionally signaled data as collision avoidance data (herein referred to as “implicit” collision avoidance data) from which to generate instructions to control the WTRUs' deferral, backoff and/or other collision avoidance behavior. However, greater control and higher efficiency can generally be achieved where the WTRU is configured to use explicit collision avoidance data alone or in combination with implicit collision avoidance data to generate collision avoidance behavior instructions.

In accordance a preferred embodiment of the present invention, explicit deferral instruction data is included in communication frames to enable WTRUs receiving the frames to generate deferral instructions to update their deferral behavior. Conventional MAC header information can be used as explicit deferral instruction data by copying or moving the MAC information to PHY header fields in communication frames to thereby be decoded sooner and more reliably by receiving WTRUs. NAV or longNAV cancellation (equivalently reset) indicator fields are preferably added to conventional communication frame structures to provide WTRUs with explicit NAV instruction data to resolve NAV or longNAV protection unfairness at receiving WTRUs. NAV update fields are preferably added to communication frames to permit unrestricted changes of local NAV values at receiving WTRUs.

With respect to communication of deferral instruction data, any deferral behavior of a WTRU, for example EIFS deferral, is preferably signaled explicitly or implicitly within a received frame. One or more fields of the transmitted frames provide deferral signaling data such that WTRUs that receive and decode all or part of the frame can determine how and for how long to defer before attempting to access the WLAN medium according to the deferral signaling data in the received frame. Additionally, one or more fields in a transmitted frame preferably provide backoff signaling data to enable receiving WTRUs to update their backoff behavior according to the backoff signaling data in a received frame. Preferably, the deferral and backoff signaling data is transmitted in the physical layer (PHY) header of a communication frame, for example in the HT-SIG field of the PHY header.

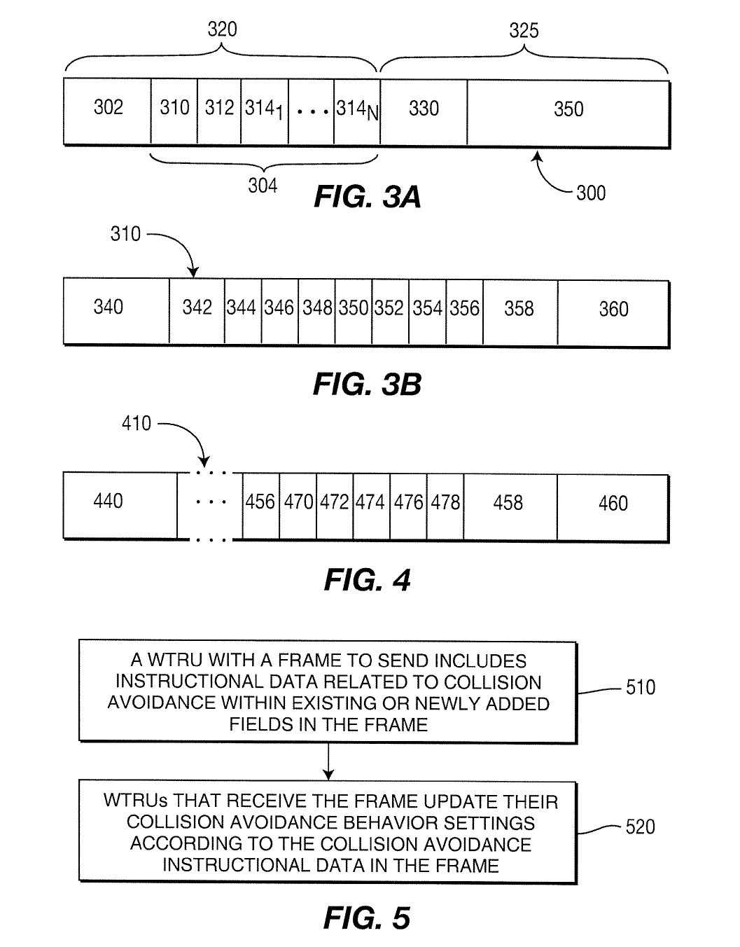

In one embodiment, deferral instruction data is provided in fields that are conventionally included in a communication frame in accordance with existing 802.11 standards. By way of example, FIG. 3A illustrates a basic frame format of a physical layer convergence protocol (PLCP) frame 300 as set forth in the TGnSync proposal for the 802.11n standard. A PLCP frame is also called the PLCP protocol data unit (PPDU) or simply a PHY frame. PLCP frames include a PLCP header 320, also referred to as the PHY header, and a MAC protocol data unit (MPDU) 325. The MPDU 325 includes a MAC header 330 and a block of data 335 or a plurality of each, if desired. Within the PLCP header, field 302 is provided for legacy header fields that are common to prior versions of the 802.11 standard including 802.11a and 802.11g. Fields 304 form are provided as a high throughput (HT) header consisting of a high throughput signal (HT-SIG) field 310 and training fields 312, 314₁-314_{N}.

As further illustrated in FIG. 3B, the HT-SIG field 310 includes such fields as a HT-length field 340, a modulation and coding set (MCS) 342, an advanced coding indicator 344, a sounding packet indicator 346, a number of high throughput training fields (HT-LTF) 348, a short guard field 350, an aggregation field 352, a scrambler seed field 354, a 20/40 bandwidth indicator 356, a Cyclic Redundancy Check (CRC) field 358 and a tail field 360. The field breakdown of a PLCP frame 300 in FIGS. 3A and 3B provides examples of fields and their relative positioning that may exist in a frame and the PHY header 320 in which deferral instruction data may be provided in accordance with the invention.

Deferral signaling data used by a WTRU to set deferral behavior may be communicated implicitly via conventional fields and data in a PLCP frame. For example, a WTRU that correctly receives and decodes conventional signaling in the HT-SIG field 310 of the PHY header 320 will acquire knowledge of a frame type (e.g. control or data) and frame length as given by various fields including, for example, the MCS field 342 and the HT-length field 340. Accordingly, the WTRU can set its deferral type and duration to correspond to the type and length of the received frame. By way of example, a WTRU may have locally stored information specifying the rate of transmission and length of a typical control frame. The WTRU, upon decoding a HT-SIG field 310 may learn that a received frame is a control frame and can then calculate appropriate deferral duration according to the locally stored control frame rate and length information.

The HT-SIG field 310 of the header may also contain signaling data for a burst of frames (i.e. frames sent from the same sender separated by SIFS or RIFS) for example via the aggregation indicator field 352. A last frame transmission burst indicator can also be provided to indicate the last frame of a burst. In accordance with the present invention, a WTRU can sets its deferral period duration to correspond to the duration of burst frames according to the signaling data for a burst of frames in the transmission burst indicator field and/or the last frame transmission burst indicator of a received frame.

To afford enhanced control, preferably deferral signaling data is communicated explicitly in a PLCP frame, preferably within the HT-SIG field 310. The WTRU is then preferably configured to generate deferral instructions based upon the explicit deferral instruction data to control its deferral behavior. A combination of conventional data referred to above in implicit communication of deferral signaling data can be used in connection with deferral signaling data communicated explicitly for the purpose of generating deferral instructions.

FIG. 4 illustrates an example of a modified HT-SIG field 410 wherein fields containing explicit deferral instruction data are added to a conventional HT-SIG field 310 in accordance with a preferred embodiment of the present invention. Fields 440-460 (not all shown) correspond to fields 340-360 of the conventional HT-SIG field 310 in FIG. 3B. The added fields for explicit deferral instruction data may include, but are not limited to, a deferral period indicator field 470 referring to any kind of IFS deferral including an EIFS deferral, an IFS duration field 472 indicating the duration of a deferral for any kind of IFS deferral, an indicator field of a response frame or any type of subsequent frame following the transmission of the current frame 474, a field referring to the type of subsequent or response frame or frames 476 including, for example, ACKs, block ACKs (BAs), receive diversity (RD) traffic, polled traffic, or SIFS or RIFS burst transmissions, and a field containing the length of the subsequent or response frame or frames 478.

By way of example, the duration of EIFS in the duration field 472 may be encoded by reference, such that a value of 1 refers to 10 microseconds (μs), and a value of 2 refers to 15 μs, or encoded directly, such that the EIFS value is obtained via multiplying the value of the field by a certain time granularity. Depending upon the encoding selected for use, the WTRU is then configured to decode the duration field data to thereby instruct the proper updating of EIFS duration.

As another example, a single field containing 2 bits within the HT-SIG field of the frame may communicate whether EIFS deferral is used and the value of EIFS. For example, ‘00’ may indicate that EIFS shall not be used, and ‘01’, ‘10’, and ‘11’ indicate that EIFS shall be used with each respective value referring to a different duration of EIFS. The WTRU is then configured to use the 2 bit value to instruct whether EIFS deferral is used.

Additionally, the deferral period indicator 470, or a field anywhere within a frame, may be used to signal EIFS cancellation to the receiving WTRU which is configured to use such data for instructing EIFS cancellation.

Other useful indicator fields for explicit deferral instruction data, not shown in FIG. 4, may be added to the HT-SIG field. Alternatively, fields for explicit deferral instruction data may be added anywhere within a frame, but frame portions decoded by a WTRU's PHY layer are preferred.

A further example new field is an indicator for a spoofed duration, which permits the spoofed duration to dynamically be requested by a transmitting WTRU. This can enable the WTRU to generate instructions to resolve issues related to NAV setting or EIFS deferral.

Other new fields for explicit collision avoidance instruction data include a power save multi-poll (PSMP) sequence indicator, and an immediate response or, equivalently, non-immediate response indicator. Immediate response may refer to responses occurring within a period less than or equal SIFS following the frame reception, while non-immediate response may refer to responses that take longer than SIFS.

Information contained or targeted for the MAC header, for example within the HT-Control field, can be used as explicit deferral instruction data by placing it or replicating it within the HT-SIG field or any part of the PHY header. Additionally, any information targeted for the MAC header that may provide other kinds of signaling information to the physical layer, including, but not limited to fields containing information on aggregation, channel sounding, and link adaptation, are preferably moved to or replicated within a part of the PHY header, preferably the HT-SIG field.

Table 1 provides a list of new fields for explicit collision avoidance instruction data and/or PHY layer signaling information that may be included within an HT-SIG field of a communication frame's PHY header in accordance with the present invention. By replicating fields in the PHY header, these fields are received and decoded more reliably by a receiving WTRU because the PHY layer header is generally transmitted at a lower rate (i.e. with more redundancy for error correction). By replicating fields in the PHY header, these fields are also available sooner to a receiving WTRU because the PHY header is decoded before the MAC header.

Preferably, the following fields, or a combination thereof, are included in the HT-SIG field of the PHY header, instead of, or in addition to, being included in the HT-Control field of the MAC header:
a. Training/sounding request bit (TRQ) to request the generation of a training/sounding response PPDU.
b. MCS Request bit (MRQ) to request MCS recommendation.
c. Antenna selection sounding request bit to request transmit antenna selection sounding.
d. Reverse direction grant bit or more-PPDU signal bit to signal from an initiator that a reverse grant is present or to signal from a responder that this is not the final PPDU of a response burst.

TABLE 1

| | Size | |
|---|---|---|
| Field | (bits) | Description |
| A-MSDU (TBD) | 1 | Set to 1 indicates presence of an A-MSDU frame |
| TRQ | 1 | Set to 1 request generation of sounding response PPDU (TBD) |
| MRQ | 1 | Set to 1 request an MCS recommendation |
| MFB | 1 | Set to 1 indicate that recommended MCS is present |
| MCS | TBD | Contains a recommended MCS, including # spatial streams, |
| | | SGI, use of advanced coding, use of STBC and other PHY |
| | | options. (TBD) |
| RDG | 1 | Set to 1 indicates that the duration/ID field of this MPDU |
| | | contains a reverse direction grant duration. |
| Implicit BAR (TBD) | 1 | Set to 1 indicates a request for BA feedback |
| HT BA | 1 | Set to 1 indicates that frame body of QoS Data frame includes |
| (TBD) | | BA bitmap(s) only |
| HT RTS | 1 | Set to 1 indicates the HT transmitter is sending an RTS frame |
| (TBD) | | |
| HT CTS | 1 | Set to 1 indicates the HT transmitter is sending a CTS frame |
| (TBD) | | |
| More-PDU | 1 | Set to 1 indicates that this is not the final PPDU of a response |
| | | burst |
| AC | 3 | Contains the AC Constraint field as specified in the RDG |
| | | document |
| EPP | 1 | Set to 1 indicates that this PPDU is protected under the EPP |
| | | procedure (TBD) |

One or more fields located in the HT-SIG field or anywhere in the PHY or MAC headers may be included to receive explicit collision avoidance instruction data that serves as an indicator for NAV or longNAV cancellation. In a preferred embodiment, a NAV or longNAV cancellation indicator is 1 bit. If a WTRU receives a frame with the NAV or longNAV cancellation indicator set, the WTRU accordingly generates an instruction to reset its NAV or LongNAV value immediately or at any time following the reception of the current frame. In addition, if the WTRU is an access point (AP), it may generate and send one or more response frames, as desired, from among the following types of response frames for the purpose of signaling possible hidden WTRUs: a CF-End frame, a CF-End frame with the NAV cancellation bit set, or any other type of response frame with the cancellation bit set. Alternatively, the AP may not send any response frame if it is known that there are no hidden WTRUs.

One or more new fields in the HT-SIG field or anywhere within the PHY or MAC headers may be included to receive explicit collision avoidance instruction data that serves as an indicator for spoofing operation cancellation such that a WTRU that receives a frame with spoofing operation cancellation indicator set accordingly generate an instruction to reset its spoofing operation value.

A NAV update field may be included, preferably within the HT-Control field or the HT-SIG field, to receive explicit collision avoidance instruction data for the purpose of communicating to a receiving WTRU if it should generate instructions to update its local NAV value according to the NAV value indicated within the frame, in particular, when received data indicates a value is lower than the WTRU's current local NAV setting. Thus, by way of a NAV update field, WTRUs in a WLAN have increased flexibility in generating instructions to update their local NAV values which accordingly improves the time it takes to recover the medium.

As an example, a NAV update field communicating a value of 1 may indicate that the WTRU should generate an instruction that the local NAV should always be updated according to the received NAV value. Then when the NAV update field communicates a value of the WTRU generates an instruction that the local NAV should be updated only if the received NAV value is larger. Alternatively, a NAV update field equal to 1 may indicate that the local NAV value may be decreased if the received NAV value is lower and the WTRU is configured to provide an instruction accordingly.

In accordance with a preferred embodiment of the present invention, a WTRU can intelligently set or update its collision avoidance behavior according to collision avoidance instruction data in the PHY header of a received communication frame even if it has encountered an error in decoding the rest of the frame following the PHY header (i.e. the MPDU). Similarly, a WTRU can set or update its collision avoidance behavior according to collision avoidance instruction data in MAC header even if it has encountered an error in decoding the rest of the frame.

FIG. 5 generally illustrates a method for signaling general collision avoidance data within a frame in accordance with an embodiment of the present invention. In step 510, a WTRU with a frame to send includes instructional data related to collision avoidance within existing or newly added fields in the frame. Such collision avoidance instruction data preferably includes at least some explicit data and may relate, for example, to any of deferral type or duration, such as IFS and EIFS deferral, NAV or longNAV update or cancellation, spoofed duration or backoff duration. Step 510 may include the moving or copying of fields from the MAC header to the PHY header of a frame to serve as explicit data to be decoded faster and more reliably by receiving WTRUs. In step 520, the WTRUs that receive the frame update their collision avoidance behavior settings according to the collision avoidance instructional data in the frame. In general, the processor of a WTRU will generate update instructions to affect such updates in response to the received collision avoidance instruction data. The collision avoidance behavior setting updates preferably include one or more of the following: deferral behavior, backoff duration, spoofed duration and NAV or longNAV value.

In a preferred implementation, a WTRU is configured to conduct wireless communications in a WLAN, such as WTRU 100. A receiver component 100_{R} is preferably configured to receive communication frames and decode communication frames to extract collision avoidance instruction data contained in the communication frames. A processor component 100_{P} is preferably configured to generate collision avoidance instructions for the WTRU according to the received collision avoidance instruction data. A transmitter component 100_{T} is operatively associated with the processor component 100_{P} and is preferably configured to selectively defer transmissions based on generated collision avoidance instructions.

The WTRU's processor component 100_{P} is also preferably configured to generate communication frames containing collision avoidance instruction data to enable the transmitter component 100_{T} to transmit generated communication frames containing collision avoidance instruction data to other WTRUs. Accordingly, the WTRU can readily be configured either as a mobile unit or an access point (AP) for an 802.11 wireless local area network (WLAN).

Preferably, the receiver component 100_{R} is configured to decode a portion of communication frames and extract collision avoidance instruction data in a physical layer. In such case, the processor component 100_{P} is preferably configured to generate instructions from the physical layer extracted collision avoidance instruction data, such as instructions which specify: whether or not to defer, a type of deferral period, the duration of a deferral period, a backoff duration, a spoofed duration, a spoofing operation reset, a NAV reset, a longNAV reset, a NAV update and/or a longNAV update.

The receiver component 100_{R} is preferably configured to decode a portion of communication frames and extract explicit collision avoidance instruction data in a physical layer and/or a MAC layer header portion of a frame. This enable the generation of the collision avoidance instructions even if other portions of the frame are not successfully decoded. The WTRU receiver component 100_{R} is more preferably configured to decode a portion of communication frames in a physical layer to extract explicit collision avoidance instruction data from one or more fields in at least one of the following locations in a received communication frame: a physical layer (PHY) header, a high throughput signal (HT-SIG) field and a high throughput control (HT-Control) field.

The WTRU may include a memory component 100_{M} configured to store information regarding the transmission rate and length of a control frame or other collision avoidance instruction data received, decoded and extracted by the receiver component. In such case, the processor component 100_{P} can be, for example, configured to generate collision avoidance instructions specifying the deferral duration according to the rate and length of a control frame stored in the memory component upon determining a received frame is a control frame from the extracted type of frame data. As another example, the processor component 100_{P} can be configured to generate collision avoidance instructions specifying a deferral type according to the extracted type of deferral data and a deferral duration equal to the time granularity for deferral duration stored in the memory component multiplied by the extracted scaling value.

Where the processor component 100_{P} is configured to generate communication frames containing explicit collision avoidance instruction data, preferably the processor component generates communication frames containing explicit collision avoidance instruction data located in at least one of the following locations: a physical layer (PHY) header, a high throughput signal (HT-SIG) field, a medium access layer (MAC) header, and a high throughput control (HT-Control) field, a modulation and coding set (MCS) field, a high throughput (HT)-length field, a frame type indicator field, a burst of frames indicator field and/or a last frame in a transmission burst indicator field. Other examples include: a deferral period indicator field, a deferral duration field, a subsequent frame indicator field, a type of subsequent frame field, a length of subsequent frame field, a spoofed duration indicator field, a power save multi-poll (PSMP) sequence indicator, an immediate response (or equivalently, non-immediate response) indicator, a LongNAV reset indicator, a NAV reset indicator and a spoofing operation reset indicator.

The processor component 100_{P} may also be configured to generate communication frames which contain a type of subsequent frame field indicating a type of subsequent frame or frames from among the following types of subsequent frames: an acknowledgement (ACK) frame, a block ACK frame, receive diversity traffic, polled traffic, a SIFS burst of frames, or a RIFS burst of frames and/or to generate communication frames with one or more fields in the MAC header copied or moved to the PHY header as explicit collision avoidance instruction data. For example, fields from the MAC header copied or moved to the PHY header as explicit collision avoidance instruction data may include: a A-MSDU field indicating an A-MSDU frame, a TRQ field requesting generation of sounding response PPDU, a MRQ field requesting an MCS recommendation, a MFB field indicating recommended MCS is present, a MCS field containing recommended MCS, a RDG field indicating duration/ID field of MPDU contains reverse direction grant duration, an implicit BAR field indicating request for BA feedback, a HT-BA field indicating frame body of QoS data frame includes BA bitmaps only, a HT-RTS field indicating the HT transmitter is sending an RTS frame, a HT-CTS field indicating the HT transmitter is sending an CTS frame, a more-PPDU field indicating it is not the final PPDU in a response burst, an AC constraint field, and an EPP field indicating that the PPDU is protected under the EPP procedure.

Although the present invention is principally intended for WLANs, it may be implemented in any type of wireless communication system, as desired. By way of example, the present invention may be implemented in any type of 802.11 or OFDM/MIMO based communication system. The present invention may also be implemented on a digital signal processor (DSP), software or middleware.

Preferably, the WTRU components which decode received collision avoidance instruction data and generate collision avoidance instructions are implemented in physical layer processing of a WTRU or MAC header processing so that full decoding of a frame is not required. Implementation in physical layer processing in advance of MAC header processing is more preferred.

Preferably, the WTRU components which decode received collision avoidance instruction data and generate collision avoidance instructions are implemented on an single integrated circuit, such as an application specific integrated circuit (ASIC). However, the components may also be readily implemented on multiple separate integrated circuits.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A wireless transmit/receive unit (WTRU) configured to conduct wireless communications in a wireless local area network (WLAN) comprising:
a receiver component configured to receive communication frames and decode communication frames to extract collision avoidance instruction data contained in the communication frames;
a processor component configured to generate collision avoidance instructions for the WTRU according to the received collision avoidance instruction data; and
a transmitter component operatively associated with the processor component configured to selectively defer transmissions based on generated collision avoidance instructions.

2. The WTRU of claim 1 wherein:
the processor component is configured to generate communication frames containing collision avoidance instruction data; and
the transmitter component is configured to transmit generated communication frames containing collision avoidance instruction data.

3. The WTRU of claim 1 wherein:
the receiver component is configured to decode a portion of communication frames and extract collision avoidance instruction data in a physical layer; and
the processor component is configured to generate at least one type of instruction from the physical layer extracted collision avoidance instruction data among the types of collision avoidance instructions which specify:
whether or not to defer,
a type of deferral period,
the duration of a deferral period,
a backoff duration,
a spoofed duration,
a spoofing operation reset,
a NAV reset,
a longNAV reset,
a NAV update, and
a longNAV update.

4. The WTRU of claim 1 wherein the processor component is configured to generate collision avoidance instructions which specify a type interframe spacing (IFS) deferral period from among a plurality of types IFS deferral periods which include extended interframe spacing (EIFS) and distributed coordination function interframe spacing (DIFS), and a corresponding deferral duration.

5. The WTRU of claim 1 wherein the processor component is configured to generate collision avoidance instructions which specify one from among a NAV value reset or a longNAV value reset, and a corresponding time delay until reset that is greater than or equal to zero.

6. The WTRU of claim 1 wherein the receiver component is configured to decode a portion of communication frames and extract explicit collision avoidance instruction data in a physical layer and/or a MAC layer header portion of a frame.

7. The WTRU of claim 1 wherein the receiver component is configured to decode a portion of communication frames in a physical layer to extract explicit collision avoidance instruction data from one or more fields in at least one of the following locations in a received communication frame: a physical layer (PHY) header, a high throughput signal (HT-SIG) field and a high throughput control (HT-Control) field.

8. The WTRU of claim 1 further comprising a memory component wherein:
the receiver component is configured to receive, decode and extract explicit collision avoidance instruction data specifying the type of frame from among a data frame or a control frame from the frame type indicator field of a received communication frame;
the memory component is configured to store information regarding the transmission rate and length of a control frame; and
the processor component is configured to generate collision avoidance instructions specifying the deferral duration according to the rate and length of a control frame stored in the memory component upon determining a received frame is a control frame from the extracted type of frame data.

9. The WTRU of claim 1 wherein:
the receiver component is configured to receive, decode and extract explicit collision avoidance instruction data specifying the number of subsequent frames from the burst of frames indicator field of a received communication frame; and
the processor is component configured to generate collision avoidance instructions specifying the deferral duration according to the extracted number of subsequent frames data.

10. The WTRU of claim 1 wherein:
the receiver component is configured to receive, decode and extract explicit collision avoidance instruction data specifying the number of subsequent frames and the type of subsequent frames from among response frames or acknowledgement frames from the burst of frames indicator field of a received communication frame; and
the processor component is configured to generate collision avoidance instructions specifying the deferral duration according to the extracted number of subsequent frames data and the extracted type of subsequent frames data.

11. The WTRU of claim 1 wherein:
the receiver component is configured to receive, decode and extract explicit collision avoidance instruction data specifying a type of IFS deferral from the deferral period indicator field and a time indicator value from among a first value or a second value from the deferral duration field of a received communication frame; and
the processor component is configured to generate collision avoidance instructions specifying the type of IFS deferral period according to the extracted type of IFS deferral data and a deferral duration from among a first deferral duration or a second deferral duration according to the extracted time indicator value being equal to the first value or the second value, respectively.

12. The WTRU of claim 1 further comprising a memory component wherein:
the receiver component is configured to receive, decode and extract explicit collision avoidance instruction data specifying a type of deferral from the deferral period indicator field and a scaling value from the deferral duration field of a received communication frame;
the memory component is configured to store a time granularity for deferral duration; and
the processor component is configured to generate collision avoidance instructions specifying a deferral type according to the extracted type of deferral data and a deferral duration equal to the time granularity for deferral duration stored in the memory component multiplied by the extracted scaling value.

13. The WTRU of claim 1 wherein:
the receiver component is configured to receive, decode and extract explicit collision avoidance instruction data specifying a 2 bit binary value from the deferral duration field; and
the processor component is configured to generate collision avoidance instructions specifying a deferral action according to the extracted 2 bit binary value from among the following:
not to perform deferral if the extracted 2 bit binary value is ‘00’,
perform EIFS deferral for a first deferral duration if the extracted 2 bit binary value is ‘01’,
perform EIFS deferral for a second deferral duration if the extracted 2 bit binary value is ‘10’, or
perform EIFS deferral for a third deferral duration if the extracted 2 bit binary value is ‘11’.

14. The WTRU of claim 1 wherein the WTRU is configured as a mobile unit for an 802.11 wireless local area network (WLAN).

15. The WTRU of claim 1 wherein the WTRU is configured as an access point (AP) for an 802.11 wireless local area network (WLAN).

16. The AP of claim 15 wherein:
the receiver is configured to extract explicit collision avoidance instruction data specifying whether or not to reset the local NAV value from the NAV cancellation indicator field in a received communication frame;
the processor component is configured to reset its local NAV value and generate one or more of the following types of response frames if the extracted data specifies NAV reset: a CF-end frame, a CF-end frame with NAV cancellation bit set, or a response frame with cancellation bit set; and
the transmitter component is configured to transmit the generated response frame or frames.

17. A wireless transmit/receive unit (WTRU) configured to conduct wireless communications in a wireless local area network (WLAN) comprising:
a processor component configured to generate communication frames containing explicit collision avoidance instruction data; and
a transmitter component configured to transmit generated communication frames containing collision avoidance instruction data.

18. The WTRU of claim 17 wherein the processor component is configured to generate communication frames containing explicit collision avoidance instruction data located in at least one of the following locations: a physical layer (PHY) header, a high throughput signal (HT-SIG) field, a medium access layer (MAC) header, and a high throughput control (HT-Control) field.

19. The WTRU of claim 17 wherein the processor component is configured to generate communication frames which contain at least one of the following fields which provide explicit collision avoidance instruction data: a modulation and coding set (MCS) field, a high throughput (HT)-length field, a frame type indicator field, a burst of frames indicator field and a last frame in a transmission burst indicator field.

20. The WTRU of claim 17 wherein the processor component is configured to generate communication frames which contain at least one of the following fields which provide explicit collision avoidance instruction data: a deferral period indicator field, a deferral duration field, a subsequent frame indicator field, a type of subsequent frame field, a length of subsequent frame field, a spoofed duration indicator field, a power save multi-poll (PSMP) sequence indicator, an immediate response (or equivalently, non-immediate response) indicator, a LongNAV reset indicator, a NAV reset indicator and a spoofing operation reset indicator.

21. The WTRU of claim 17 wherein the processor component is configured to generate communication frames which also contain at least one of the following fields which provide explicit collision avoidance instruction data: a modulation and coding set (MCS) field, a high throughput (HT)-length field, a frame type indicator field, a burst of frames indicator field and a last frame in a transmission burst indicator field.

22. The WTRU of claim 17 wherein the processor component is configured to generate communication frames which contain a deferral period indicator field specifying whether or not to defer for an IFS deferral period.

23. The WTRU of claim 17 wherein the processor component is configured to generate communication frames which contain a deferral period indicator field specifying whether or not to defer for an EIFS deferral period.

24. The WTRU of claim 17 wherein the processor component is configured to generate communication frames which contain a deferral period indicator field specifying the cancellation of an EIFS deferral period.

25. The WTRU of claim 17 wherein the processor component is configured to generate communication frames which contain a type of subsequent frame field indicating a type of subsequent frame or frames from among the following types of subsequent frames: an acknowledgement (ACK) frame, a block ACK frame, receive diversity traffic, polled traffic, a SIFS burst of frames, or a RIFS burst of frames.

26. The WTRU of claim 17 wherein the processor component is configured to generate communication frames with one or more fields in the MAC header copied or moved to the PHY header as explicit collision avoidance instruction data.

27. The WTRU of claim 26 wherein fields copied or moved to the PHY header from the MAC header include at least one of the following fields: a A-MSDU field indicating an A-MSDU frame, a TRQ field requesting generation of sounding response PPDU, a MRQ field requesting an MCS recommendation, a MFB field indicating recommended MCS is present, a MCS field containing recommended MCS, a RDG field indicating duration/ID field of MPDU contains reverse direction grant duration, an implicit BAR field indicating request for BA feedback, a HT-BA field indicating frame body of QoS data frame includes BA bitmaps only, a HT-RTS field indicating the HT transmitter is sending an RTS frame, a HT-CTS field indicating the HT transmitter is sending an CTS frame, a more-PPDU field indicating it is not the final PPDU in a response burst, an AC constraint field, and an EPP field indicating that the PPDU is protected under the EPP procedure.

28. The WTRU of claim 17 wherein the WTRU is configured as a mobile unit for an 802.11 wireless local area network (WLAN).

29. The WTRU of claim 17 wherein the WTRU is configured as an access point (AP) for an 802.11 wireless local area network (WLAN).

30. A wireless transmit/receive unit (WTRU) configured to conduct wireless communications in a wireless local area network (WLAN) comprising:
a processor component configured to generate communication frames with one or more fields from the MAC header copied or moved to the PHY header as physical layer instruction data; and
a transmitter component configured to transmit generated communication frames.

31. The WTRU of claim 30 wherein fields copied or moved to the PHY header from the MAC header include at least one of the following fields: a A-MSDU field indicating an A-MSDU frame, a TRQ field requesting generation of sounding response PPDU, a MRQ field requesting an MCS recommendation, a MFB field indicating recommended MCS is present, a MCS field containing recommended MCS, a RDG field indicating duration/ID field of MPDU contains reverse direction grant duration, an implicit BAR field indicating request for BA feedback, a HT-BA field indicating frame body of QoS data frame includes BA bitmaps only, a HT-RTS field indicating the HT transmitter is sending an RTS frame, a HT-CTS field indicating the HT transmitter is sending an CTS frame, a more-PPDU field indicating it is not the final PPDU in a response burst, an AC constraint field, and an EPP field indicating that the PPDU is protected under the EPP procedure.

32. A method for a wireless transmit/receive unit (WTRU) to conduct wireless communications in a wireless local area network (WLAN) comprising:
receiving communication frames containing collision avoidance instruction data;
decoding received communication frames to extract collision avoidance instruction data;
generating collision avoidance instructions for the WTRU according to the received collision avoidance instruction data; and
selectively deferring transmissions based on generated collision avoidance instructions.

33. The method of claim 32 further comprising:
generating communication frames containing collision avoidance instruction data; and
transmitting generated communication frames containing collision avoidance instruction data.

34. The method of claim 32 wherein:
the decoding received communication frames to extract collision avoidance instruction data is performed in a physical layer process that partially decodes a frame; and
the generating of collision avoidance instructions includes generating collision avoidance instructions from physical layer extracted collision avoidance instruction data of at least one type from among the types of collision avoidance instructions which specify:
whether or not to defer,
a type of deferral period,
the duration of a deferral period,
a backoff duration, a spoofed duration,
a spoofing operation reset,
a NAV reset,
a longNAV reset,
a NAV update, and
a longNAV update.

35. The method of claim 32 wherein:
the generating of collision avoidance instructions specifies a type interframe spacing (IFS) deferral period from among a plurality of types IFS deferral periods which include extended interframe spacing (EIFS) and distributed coordination function interframe spacing (DIFS), and a corresponding deferral duration.

36. The method of claim 32 wherein:
the generating of collision avoidance instructions specifies one from among a NAV value reset or a longNAV value reset, and a corresponding time delay until reset that is greater than or equal to zero.

37. The method of claim 32 wherein:
the decoding of a received communication frames is performed in a physical layer process or a MAC header decoding process to extract the collision avoidance instruction data in a physical layer and/or a MAC layer header portion of a frame.

38. The method of claim 32 wherein:
the decoding of received communication frames is performed in a physical layer process to extract explicit collision avoidance instruction data from one or more fields in at least one of the following locations in a received communication frame: a physical layer (PHY) header, a high throughput signal (HT-SIG) field, and a high throughput control (HT-Control) field.

39. The method of claim 32 further comprising storing information regarding the transmission rate and length of a control frame wherein:
the decoding of received communication frames extracts explicit collision avoidance instruction data specifying the type of frame from among a data frame or a control frame from the frame type indicator field of a received communication frame; and
the generating of collision avoidance instructions specifies the deferral duration according to the stored rate and length of a control frame upon determining a received frame is a control frame from the extracted type of frame data.

40. The method of claim 32 wherein:
the decoding of received communication frames extracts explicit collision avoidance instruction data specifying the number of subsequent frames from the burst of frames indicator field of a received communication frame; and
the generating of collision avoidance instructions specifies the deferral duration according to the extracted number of subsequent frames data.

41. The method of claim 32 wherein:
the decoding of received communication frames extracts explicit collision avoidance instruction data specifying the number of subsequent frames and the type of subsequent frames from among response frames or acknowledgement frames from the burst of frames indicator field of a received communication frame; and
the generating of collision avoidance instructions specifies the deferral duration according to the extracted number of subsequent frames data and the extracted type of subsequent frames data.

42. The method of claim 32 wherein:
the decoding of received communication frames extracts explicit collision avoidance instruction data specifying a type of IFS deferral from the deferral period indicator field and a time indicator value from among a first value or a second value from the deferral duration field of a received communication frame; and
the generating of collision avoidance instructions specifies the type of IFS deferral period according to the extracted type of IFS deferral data and a deferral duration from among a first deferral duration or a second deferral duration according to the extracted time indicator value being equal to the first value or the second value, respectively.

43. The method of claim 32 further comprising storing information regarding a time granularity for deferral duration wherein:
the decoding of received communication frames extracts explicit collision avoidance instruction data specifying a type of deferral from the deferral period indicator field and a scaling value from the deferral duration field of a received communication frame; and
the generating of collision avoidance instructions specifies a deferral type according to the extracted type of deferral data and a deferral duration equal to the stored time granularity for deferral duration multiplied by the extracted scaling value.

44. The method of claim 32 wherein:
the decoding of received communication frames extracts explicit collision avoidance instruction data specifying 2 bit binary value from the deferral duration field; and
the generating of collision avoidance instructions specifies a deferral action according to the extracted 2 bit binary value from among the following:
not to perform deferral if the extracted 2 bit binary value is ‘00’,
perform EIFS deferral for a first deferral duration if the extracted 2 bit binary value is ‘01’,
perform EIFS deferral for a second deferral duration if the extracted 2 bit binary value is ‘10’, or
perform EIFS deferral for a third deferral duration if the extracted 2 bit binary value is ‘11’.

45. The method of claim 32 wherein:
the decoding of received communication frames extracts collision avoidance instruction data specifying whether or not to reset the local NAV value from the NAV cancellation indicator field in a received communication frame, and
the generating of collision avoidance instructions for the WTRU according to the received collision avoidance instruction data specifies to reset its local NAV value and generate one or more of the following types of response frames if the extracted data specifies NAV reset: a CF-end frame, a CF-end frame with NAV cancellation bit set, or a response frame with cancellation bit set further comprising:
transmitting the generated response frame or frames.

46. A method for a wireless transmit/receive unit (WTRU) to conduct wireless communications in a wireless local area network (WLAN) comprising:
generating communication frames containing explicit collision avoidance instruction data; and
transmitting generated communication frames containing collision avoidance instruction data.

47. The method of claim 46 wherein:
the generating of communication frames containing explicit collision avoidance instruction data is such that the collision avoidance instruction data is located in at least one of the following locations: a physical layer (PHY) header, a high throughput signal (HT-SIG) field, a medium access layer (MAC) header, and a high throughput control (HT-Control) field.

48. The method of claim 46 wherein:
the generating of communication frames includes at least one of the following fields which provide explicit collision avoidance instruction data: a modulation and coding set (MCS) field, a high throughput (HT)-length field, a frame type indicator field, a burst of frames indicator field and a last frame in a transmission burst indicator field.

49. The method of claim 46 wherein:
the generating of communication frames includes at least one of the following fields which provide explicit collision avoidance instruction data: a deferral period indicator field, a deferral duration field, a subsequent frame indicator field, a type of subsequent frame field, a length of subsequent frame field, a spoofed duration indicator field, a power save multi-poll (PSMP) sequence indicator, an immediate response (or equivalently, non-immediate response) indicator, a LongNAV reset indicator, a NAV reset indicator and a spoofing operation reset indicator.

50. The method of claim 46 wherein:
the generating of communication frames includes at least one of the following fields which provide explicit collision avoidance instruction data: a modulation and coding set (MCS) field, a high throughput (HT)-length field, a frame type indicator field, a burst of frames indicator field and a last frame in a transmission burst indicator field.

51. The method of claim 46 wherein:
the generating of communication frames containing explicit collision avoidance instruction data includes a deferral period indicator field specifying whether or not to defer for an IFS deferral period.

52. The method of claim 46 wherein:
the generating of communication frames containing explicit collision avoidance instruction data includes a deferral period indicator field specifying whether or not to defer for an EIFS deferral period.

53. The method of claim 46 wherein:
the generating of communication frames containing explicit collision avoidance instruction data includes a deferral period indicator field specifying the cancellation of an EIFS deferral period.

54. The method of claim 46 wherein:
the generating of communication frames containing explicit collision avoidance instruction data includes a type of subsequent frame field indicating a type of subsequent frame or frames from among the following types of subsequent frames: an acknowledgement (ACK) frame, a block ACK frame, receive diversity traffic, polled traffic, a SIFS burst of frames, or a RIFS burst of frames.

55. The method of claim 46 wherein:
the generating of communication frames containing explicit collision avoidance instruction data includes the copying or moving of one or more fields in the MAC header to the PHY header.

56. The method of claim 55 wherein:
the copying or moving of fields includes at least one of the following fields: a A-MSDU field indicating an A-MSDU frame, a TRQ field requesting generation of sounding response PPDU, a MRQ field requesting an MCS recommendation, a MFB field indicating recommended MCS is present, a MCS field containing recommended MCS, a RDG field indicating duration/ID field of MPDU contains reverse direction grant duration, an implicit BAR field indicating request for BA feedback, a HT-BA field indicating frame body of QoS data frame includes BA bitmaps only, a HT-RTS field indicating the HT transmitter is sending an RTS frame, a HT-CTS field indicating the HT transmitter is sending an CTS frame, a more-PPDU field indicating it is not the final PPDU in a response burst, an AC constraint field, and an EPP field indicating that the PPDU is protected under the EPP procedure.

57. A method for a wireless transmit/receive unit (WTRU) to conduct wireless communications in a wireless local area network (WLAN) comprising:
generating communication frames with one or more fields from the MAC header copied or moved to the PHY header as physical layer instruction data; and
transmitting generated communication frames containing physical layer instruction data.

58. The method of claim 57 wherein:
the copying or moving of fields includes at least one of the following fields: a A-MSDU field indicating an A-MSDU frame, a TRQ field requesting generation of sounding response PPDU, a MRQ field requesting an MCS recommendation, a MFB field indicating recommended MCS is present, a MCS field containing recommended MCS, a RDG field indicating duration/ID field of MPDU contains reverse direction grant duration, an implicit BAR field indicating request for BA feedback, a HT-BA field indicating frame body of QoS data frame includes BA bitmaps only, a HT-RTS field indicating the HT transmitter is sending an RTS frame, a HT-CTS field indicating the HT transmitter is sending an CTS frame, a more-PPDU field indicating it is not the final PPDU in a response burst, an AC constraint field, and an EPP field indicating that the PPDU is protected under the EPP procedure.
